(19) United States
(12) Patent Application Publication
(10) Pub. No.: US 2013/0075331 A1
(43) Pub. Date: Mar. 28, 2013

(54) METHOD FOR FLUORESCENCE-BASED FOULING FORECASTING AND OPTIMIZATION IN MEMBRANE FILTRATION OPERATIONS

(71) Applicants: Ramila Hishantha Peiris, Waterloo (CA); Hector Marcelo Budman, Toronto (CA); Christine Moresoli, Waterloo (CA); Raymond L. Legge, Waterloo (CA)

(72) Inventors: Ramila Hishantha Peiris, Waterloo (CA); Hector Marcelo Budman, Toronto (CA); Christine Moresoli, Waterloo (CA); Raymond L. Legge, Waterloo (CA)

(21) Appl. No.: 13/703,313

(22) PCT Filed: Jun. 10, 2011
(86) PCT No.: PCT/CA2011/000674

§ 371 Date: Dec. 10, 2012

Related U.S. Application Data
(60) Provisional application No. 61/344,208, filed on Jun. 10, 2010.

(51) Int. Cl. B01D 65/10

(52) U.S. Cl. CPC B01D 65/10
USPC 210/636; 210/650

(57) ABSTRACT

The present invention provides a fluorescence-based modeling method that is capable of capturing the dynamic changes of different membrane foulant fractions that occur in fluid filtration operations. Principal component analysis is utilized to de-convolute spectral information captured within fluorescence EEMs into principal component scores that are related to different known foulant groups. The principal component scores are then used as states within a system of differential equations representing approximate mass balances of the main foulant groups to obtain a dynamic forecasting of membrane fouling. Based on the fouling dynamics forecasted by this modeling method, an optimization strategy can be developed for estimating the optimal membrane back-washing scenario for minimizing energy consumption while maximizing clean fluid production.

### TECHNICAL FIELD

The present invention relates to membrane filtration processes and in particular to a method for fluorescence-based fouling forecasting and optimization in membrane filtration operations.

### BACKGROUND OF THE INVENTION

Membrane-based technologies are widely used in drinking water applications to achieve different treatment objectives such as improved removal of colloidal/particulate matter, pathogenic organisms, natural organic matter (NOM) and salinity in water. Different types of membrane systems such as microfiltration, ultrafiltration (UF), nanofiltration and reverse osmosis are being increasingly used individually or in combination (hybrid mode) to accomplish these treatment objectives and to produce drinking water with consistent quality. Membrane-based technology also allows a smaller footprint for the treatment facilities compared to conventional treatment processes. However, membrane fouling, which is the result of the accumulation of materials (foulants) on the surface and/or in the pores of the membranes, is a major constraint when considering both the adoption and performance consistency of membrane-based treatment operations. In particular, membrane fouling decreases membrane permeability and increases water treatment operating costs, for example, by necessitating frequent cleaning. NOM fractions, such as humic substances (HS), protein- and polysaccharide-like substances as well as colloidal/particulate matter present in water, are mainly responsible for membrane fouling in drinking water applications. In practise, membrane fouling is controlled by implementing cleaning operation schemes that include membrane back-washing (also known as back-flushing) and chemical cleaning of fouled membranes.

Fouling increases operational costs as a result of permeate flux decline and/or increased energy consumption due to higher trans-membrane pressure (TMP) requirements needed as the driving force for the production of drinking water. In addition, frequent chemical cleaning of fouled membranes leads to rapid deterioration of membrane performance, shortened service life and increased costs.

Efficient use of fouling controlling strategies for preventing or reducing membrane fouling while ensuring a high production of water flux is therefore essential to reduce the energy demand and other operational costs associated with fouling for sustainable operation of membrane-based drinking water treatment operations. This can be achieved by optimising the operation of membrane filtration processes.

Optimization of a membrane filtration operation requires a model that is capable of accurately forecasting the extent of reversible and irreversible membrane fouling in a fluid filtration operation, for example, from a raw water feed. Use of such a prediction model would enable one to forecast fouling behaviour throughout the membrane filtration process, rather than at static time points. Use of these model forecasts could then be used to adjust UF back-washing times to achieve minimum energy consumption and maximize drinking water production.

While some prior art references have focused on achieving the objective of optimizing membrane filtration operation by assessing and/or predicting membrane fouling behaviour using mechanistic modeling approaches (Bowen et al. Steps of membrane blocking in flux decline during protein microfiltration. J Membrane Sci. 1995;101(1-2):153.; Tansel et al. Characterization of fouling kinetics in ultrafiltration systems by resistances in series model. Desalination. 2000;129(1):7-14; Chang and Benjamin. Modeling formation of natural organic matter fouling layers on ultrafiltration membranes. J Environ Eng, 2003;129(1):25-32; Taniguchi et al. Modes of natural organic matter fouling during ulrafiltration. Environ Sci Tech., 2003;37(8);1676-1683; and Bolton et al. Combined models of membrane fouling: Development and application to microfiltration and ultrafiltration of biological fluids. J Membrane Sci. 2006;277(1-2):75-84) these references focused mainly on dead-end and a few cross-flow membrane filtration systems that did not involve membrane back-washing cycles which are typically applied in drinking water treatment systems. Further, these modeling approaches are not suitable for successfully predicting membrane fouling in drinking water applications.

Modeling methods referred to as empirical or black-box approaches such as artificial neural networks (U.S. Patent Publication No. 2005/0258098), empirical models (Shengji et al., An empirical model for membrane flux prediction in ultrafiltration of surface water. Desalination, 2008; 145(1):223-231) and genetic programming (Lee et al., Prediction of membrane fouling in the pilot-scale microfiltration system using genetic programming. Desalination, 2009; 247(1-3_{—};285-294) have also been used to correlate membrane fouling with long-term membrane feed water quality parameters and operation data such as turbidity, temperature, perate flux, dissolved organic carbon content (DOC) and TMP in pilot scale filtration studies. However, these feed water quality parameters are not always clearly correlated to the evolution of fouling over time. As a result, the successful implementation of optimization strategies for fouling control based on these black-box models is not always warranted. These models are not able to capture the changes in the different membrane foulant fractions in water during filtration, nor can they relate different fouling behaviour to individual membrane foulant fractions. As a result, since the individual relationships between the input variables and the predicted membrane flux are not developed based on engineering criteria, the successful implementation of optimization strategies for fouling control based on these black-box models is not always warranted. In addition, from amembrane research stand point that is geared towards improving membrane fouling characteristics, the above mentioned black-box techniques are not suitable for relating the degree of fouling to the relative concentrations of NOM and other fouland components present in water and are not helpful in addressing remedies for controlling fouling.

In view of the foregoing, a need exists for a novel and inventive modeling method for enabling rapid monitoring of the performance of membrane-based drinking water treatment applications with high sensitivity, successfully forecasting membrane fouling in such applications, including differentiating major membrane fouland fractions, and optimizing membrane filtration operations in terms of minimizing the energy spent per unit amount of drinking water produced. Such method must be capaable of forecasing different fouling behaviours corresponding to changes in membrane feed water quality in order to detect high membrane fouling events well in advance, thus enabling the implementation of appropriate process optimization measures to ensure sustainable operation of drinking water treatment systems.

### SUMMARY OF THE INVENTION

The present invention proposes a fluorescence-based modeling method that is capable of capturing the dynamic changes of different membrane foulant fractions that occur during fluid filtration operations, such as through the UP of natural water for the production drinking water. This method is primarily based on fluorescence excitation-emission matrix (EEM) measurements made during UF operation to characterize different membrane foulant components present in water. In this regard, specific fluorescence features corresponding to HS- and protein-like materials, and particulate/colloidal matter, present in water are captured using a fluorescence E0EM based approach. By combining the fluorescence EEM based approach with other available fluid filtration measurements, such as trans-membrane pressure, permeate flux, turbidity, and DOC (or any combination of these measurements), the predictive accuracy of the modeling method may be enhanced further.

The fluorescence EEMs capture a large number of intensity readings recorded at different excitation and emission wavelengths for natural water samples. Compared to other available NOM membrane foulant characterization methods, this approach is capable of differentiating the major membrane foulant fractions and is suitable for performing rapid, direct and accurate analysis with high instrumental sensitivity.

Next, principal component analysis (PCA) is utilized to de-convolute spectral information captured within fluorescence EEMs into principal components (PCs) that are related to HS, protein-like and colloidal/particulate matter present in natural water. This PC score-based approach is suitable for rapid monitoring of the performance of a membrane-based drinking water treatment system with high sensitivity. PC scores are generated, which scores correspond to the fluorescence EEMs captured over the course of the UF filtration operation containing cycles of permeation and membrane back-washing.

The PC scores are then used as states within a system of differential equations representing approximate mass balances of the main foulant groups (i.e. HS, protein-like and colloidal/particulate matter). The resulting model can be viewed as a hybrid model where dynamic balances are performed over PC scores obtained from a PCA of experimentally obtained fluorescence data. This model is then used to forecast membrane permeability and fouling. Although this model is primarily based on fluorescence data, other standard fluid filtration measurements such as trans-membrane pressure, permeate flux, turbidity, and/or DOC (Dissolved Organic Carbon) can be combined in the model with the fluorescence data in order to improve predictive accuracy. Based on the UP fouling dynamics predicted by this modeling method, an optimization strategy can be developed for estimating the optimal membrane back-washing scenario for minimizing energy consumption while maximizing clean fluid (e.g. drinking water) production. As described herein, optimization may be achieved by employing a genetic algorithm that iteratively searches for an optimal cleaning schedule over the future time horizon for which the membrane fouling forecasts are generated. As the method of the present invention is able to forecast membrane fouling behaviour, this method is ideal for use in optimizing membrane filtration operations. In addition, the method described herein is also able to identify specific membrane foulants that contribute to reversible and irreversible, fouling of membranes in drinking water applications.

In one aspect of the present invention, a method is provided for forecasting the accumulation of foulants on a membrane dining the course of fluid filtration operation. In the method, fluorescence intensities are measured for feed (source), retentate and permeate fluid samples at time intervals of fluid filtration operation to generate fluorescence intensity values corresponding to each fluid sample. The fluorescence intensity values are rearranged to produce a data matrix, wherein each row of the data matrix contains fluorescence data points corresponding to each fluid sample. Applying principal component analysis to the data matrix, principal component scores are generated, wherein each principal component score represents a quantity of a corresponding foulant species group within each fluid sample. Balances on the principal component scores are subsequently performed by calculation of the accumulation of each group of foulant species on the membrane, wherein the accumulation of each group of foulant species on the membrane is calculable at any given time interval (t) of fluid filtration operation. Calculation of the accumulation of each group of foulant species on the membrane may be taken from the net effect of the following mass flows, amount of foulant species in the feed or retentate, amount of foulant species in the permeate, and amount of foulant species removed by membrane cleaning. By correlating to the balanced principal component scores at time t, membrane resistance can he forecasted for any given time interval. Using this foulant forecasting model, a membrane cleaning schedule for minimizing the energy required for fluid filtration operation and maximizing clean fluid production, can be designed.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to he understood that the phraseology and terminology employed herein are for the purpose of description and should not be regarded as limiting.

### BRIEF DESCRIPTION OF THE DRAWINGS

In the drawings, preferred embodiments of the invention are illustrated by way of example. It is to be expressly understood that the description and drawings are only for the purpose of illustration and as an aid to understanding, and are not intended as a definition of the limits of the invention.

FIG. 1 illustrates a bench-scale ultrafiltration cross flow set-up.

FIG. 2A and FIG 2B show 3D illustrations of the loading matrices of (a) PC-1, (b) PC-2, (c) PC-3 and (d) PC-4 generated by the PCA of 60 kDa data.

FIG. 3 shows 3D illustrations of the loading matrices of PC-1, PC-2 and PC-3 generated by the PCA of 20 kDa data.

FIG. 4A and FIG. 4B show model predictions (lines) and experimentally measured (symbols) normalized permeate water flux for selected. (A) 60 kDa and (B) 20 KDa UF experiments of low, medium and high membrane fouling situations.

FIG. 5A and FIG. 5B show model predictions (lines) and experimentally measured (symbols) normalized permeate water flux obtained for (A) 60 kDa and (B) 20 kDa UF operations with normal back-washing (BW) times (every hour) and optimized back-washing times.

FIG. 6A and FIG. 6B illustrate typical fluorescence features seen in the (A) fluorescence EEM for source water and (B) 3D view of the same EEM.

FIG. 7 illustrates the contribution of humic substances (PC-1), colloidal/particulate (PC-2 and PC-4) and protein-like (PC-3) matter on membrane resistance.

### DETAILED DESCRIPTION OF THE INVENTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention.

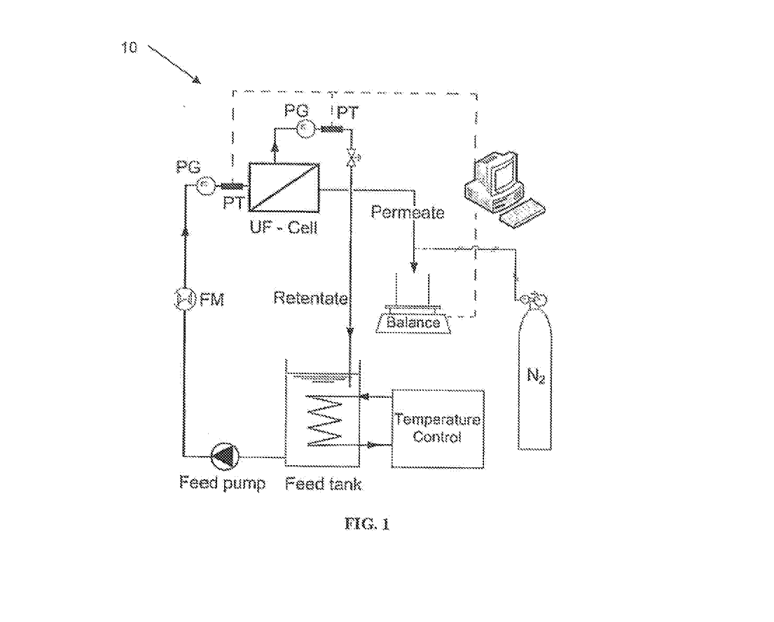

As previously discussed, the present invention proposes a novel fluorescence-based approach for modeling and predicting different fouling dynamics in an ultrafiltration (UF) process for drinking water treatment. Principal component analysis (PCA) is utilized to extract principal components (PCs), related to major membrane foulant groups, from fluorescence excitation-emission matrix measurements captured during the UF of natural river water using a bench-scale membrane cross-flow set-up of the form depicted in FIG. 1 hereof, and shown generally at reference numeral 10, wherein symbol FM denotes the flow meter, PT denotes the pressure transducer, and PC denotes the pressure gauge. Note, however that other membrane filtration configurations, such as a UP dead-end set-up, may be utilized without affecting the utility of the method described herein. The evolution of the PC scores over the filtration time is then related to membrane fouling osing PC score balanced-based differential equations. The accuracy of the predictions can be further improved by combining fluorescence with other available fluid filtration measurements, including but not limited to, trans-membrane pressure, turbidity, permeate flux and DOC.

The proposed approach is suitable for forecasting fouling behaviours with good accuracy based solely on fluorescence data collected 15 minutes into the filtration process. While the model predictions are based on the fluorescence EEM measurements captured at time=15 minutes of the UF operation, any reasonable time period which allows sufficient time for fouling control strategies to be implemented, may be employed. The method of the present invention is especially applicable for forecasting high fouling events that are often harmful for membranes or challenging for the efficient production of drinking water to meet consumer demand. As further described herein, the method of the present invention was tested experimentally as a basis for optimization by modifying the UF back-washing times with the objective of minimizing energy consumption and maximizing water production. The method described herein is also useful for identifying the fouling groups contributing to reversible and irreversible membrane fouling.

In the example embodiment described below, source water was filtered using a 200 micron filter and used as the feed in UF experiments. The DOC of the feed ranged from 3.9-6.5 mg/L and its turbidity values were in the range of 1.2-3 NTU. The source water was stored at 4° C. and used within 48 hours of the collection time.

Next, UF experiments were conducted at constant TMP using a bench-scale flat sheet cross-flow set-up (10) as illustrated In FIG. 1. The membrane cross-flow cell holder had an effective membrane area of 42 cm². Flat sheet UF membranes with a molecular weight cut-off (MWCO) size of 20 kDa and 60 kDa were used. Contact angle measurements performed on virgin 20 kDa and 60 kDa membranes were 72±2* (n=6) and 80±1* (n=6), while the initial pure water flux at TMP=15 psi (103.4 kPa) were ˜1.6 and ˜2.4 L/min.m², respectively. A new membrane was used for each filtration run and prior to the start of each run, the membranes were compacted at 15 psi using Milli-Q water until a stable permeate flow was achieved.

Feed water directed to the membrane set-up was maintained at 0.6 L/min with a TMP of 15 psi. Retentate was circulated back to the feed tank which contained 22 L of water that was maintained at ˜25±1° C. using a temperature controller. The permeate water was continuously removed and its mass and corresponding permeate flux was recorded using a balance connected to a computer using a LabView™-based interface.

The filtration consisted of a two step operation cycle: (1) permeation period and (2) back-washing for 20 seconds. For non-optimized conditions, the permeation period was 1 hour while for optimized back-washing the permeation period was adjusted according to the back-washing times determined from the solution of an optimization problem as discussed below. Back-washing of the membrane was implemented by forcing the permeate (which is the liquid in the permeate pipe and permeate channels of the membrane ceil holder) in the opposite direction through the membrane using Nitrogen gas (N₂) at 10 psi (68.9 kPa). During the back-washing, feed flow was maintained over the membrane surface to induce shear force on the membrane surface thus assisting in the removal of foulants. Fluorescence EEMs of both retentate and permeate were recorded at intervals (in this example, 15 minute intervals) during the course of the filtration.

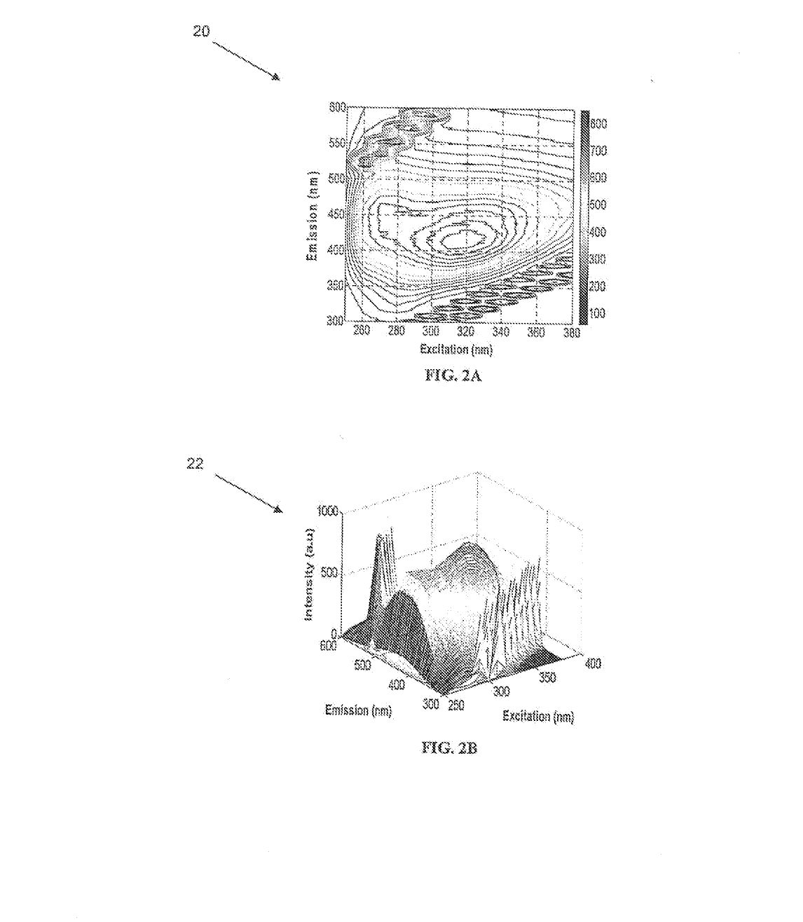

Fluorescence analysis was then used to record fluorescence EEMs of the feed (source water), retentate and permeate samples. The fluorescence EEMs of source water contained fluorescence regions that are representative of the presence of major membrane foulants such as HS- and protein-like NOM. The fluorescence spectral region (α) at excitation wavelength (Ex) ˜320 nm and emission wavelength (Em) ˜415 nm and region (β) at Ex/Em ˜270 nm/460 nm, indicated in the fluorescence EEM of the source water in FIG. 2A and FIG. 2B, wherein FIG. 2B represents a 3D view (22) of the EEM (20) of FIG. 2A, and wherein Rayleigh light scattering (RS) regions are indicated by dashed lines. During the course of the fluorescence analyses, there were no significant differences in Raman scattering peak intensities recorded for Milii-Q water at Ex/Em ˜348 nm/396 nm (i.e. difference was less than 2%), confirming that there were no significant fluctuations in the performance of the spectrofluorometer lamp or other hardware. The temperature of the water samples were maintained at room temperature (˜25° C.) during the analysis. The pH of all the water samples did not change significantly (pH˜7.8-8.4) during the experiments and no pH adjustment was made prior to the fluorescence analysis as fluorescence EEMs are not significantly affected by small pH differences.

The fluorescence EEM of each sample contained 4214 excitation and emission coordinate points. The fluorescence intensity values corresponding to all 4214 coordinate points (spectral variables) of each EEM were rearranged following the fluorescence EEM data rearrangement procedure described by Peiris et al. (2010). Identifying fouling events in a membrane-based drinking water treatment process using principal component analysis of fluorescence excitation-emission matrices. Water Res. 44(1), 185-194.]. This resulted in a n×4214 fluorescence data matrix, with each row containing fluorescence EEM data points of each sample, where n represents the total number of samples composed of both retentate and permeate samples obtained during the UF experiments as described above. This procedure was followed in order to generate two data matrices referred to as matrix X60 and matrix X20 for UF experiments performed with 60 kDa and 20 kDa membranes, respectively. X60 and X29 data matrices contained 525 and 560 fluorescence EEMs from 15 and 16 different UF experiments, respectively.

Next PCA was performed on matrices X60 and X20 separately to generate PC scores (as explained in Peiris et al, (2010), Water Res. 44(1), 185-194). PCA is generally used to extract a smaller set of underlying new variables that are uncorrolated, mutually independent (orthogonal) and mathematically represented by linear combinations of original variables in the X matrix (X60 or X20 matrix in this case). These new variables, referred to as PCs, are able to describe major trends in the original spectral data sets of X60 and X20. PCA decomposes the data matrix X as the sum of the outer product of vectors sᵢ and pᵢ plus a residual matrix E as presented in Equation 1.1, below.

$$X = {\sum }_{i = 1}^{n} {s}_{i} \cdot {p}_{i} + E \qquad ( 1.1 )$$

The sᵢ vectors are known as scores (i.e. values) on the PCs (i.e. new variables) extracted by PCA. The pᵢ vectors are known as loadings and contain information on how the variables (fluorescence variables in this case) relate to each other. By examining the loading values related to each PC, it is possible to understand which original spectral variables in the X matrix are better explained by each PC. Before performing PCA analysis, both X60 and X20 matrices were auto-scaled, i.e. adjusted to zero mean and unit variance by dividing each column by its standard deviation. To determine the number of PCs that were statistically significant in capturing the underlying features in the X60 and X20 data sets, the known leave-one-out cross-validation method was implemented. All computations were performed using the PLS Toolbox 5.2 (TM) within die MATLAB 7.8.0 (TM) computational environment.

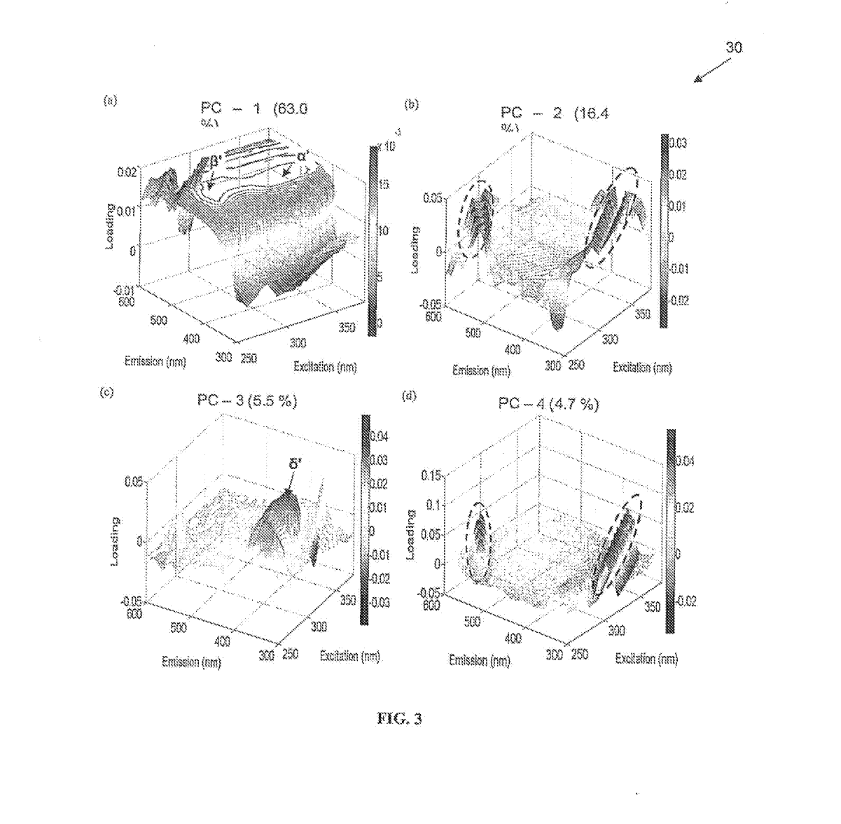

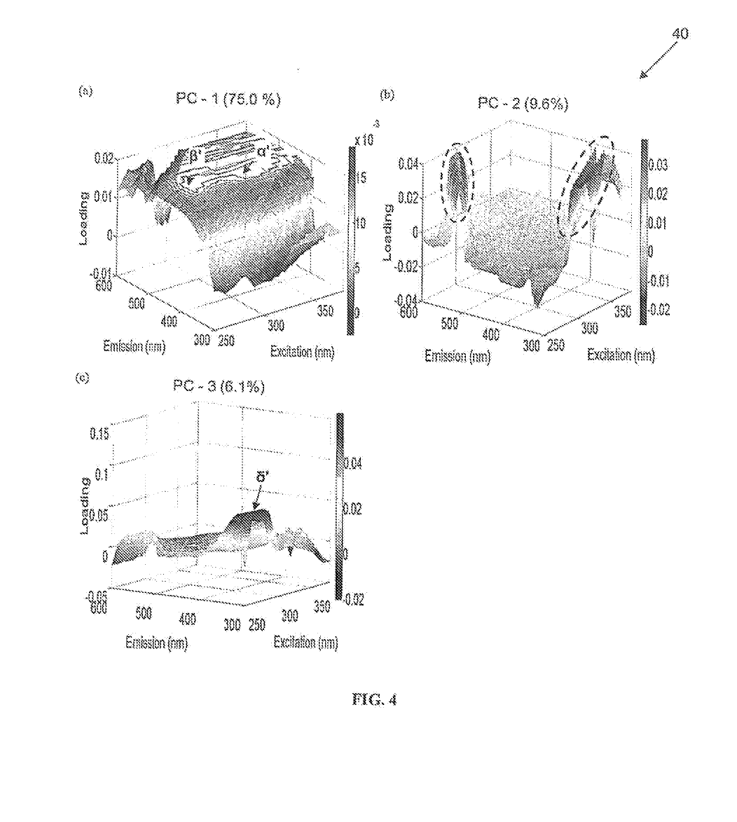

PCA of X60 and X20 matrices generated four and three statistically significant PCs, respectively, capturing nearly 90% of the total variance present in the original spectral variables obtained from 60 kDa and 20 kDa UF experiments, as detailed in Table 1 below. These PCs were found to be related to different membrane foulant fractions present in water as shown to Table 1. This was verified by examining the loading plots corresponding to each PC, (generated from the loading values, i.e. pᵢ values). For example, the loading peak of PC-1 appeared in the same location where the fluorescence EEM regions related to HS-like MOM. Similar observations were made with PC-2, PC-3 and PC-4 in relation to the foulant fractions they represent as indicated in Table 1. The loading plots of each PC corresponding to 60 kDa and 20 kDa UF experiments can be found in FIG. 3 and FIG. 4. The loading plots in FIG. 3 are indicated by reference numeral 30, while the loading plots in FIG. 4 are denoted by reference numeral 40. The remaining variance (˜10%) in each case was considered to be due to the combination of unexplained variance by these PCs and the instrumental noise (determined to be less than 5% of the intensity readings) in the fluorescence measurements. Although it is possible to capture the remaining variance by generating additional PCs, additional PCs were not found to be related to any major membrane foulant fractions present in water.

TABLE 1
VARIANCE CAPTURED IN THE PCA Of THE X60 AND
X20 MATRICES

| | X60 matrix | | X20 matrix | |
|---|---|---|---|---|
| | (60 kDa UF | | (20 kDa UF | |
| | spectral data) | | spectral data) | |
| | Variance | Related | Variance | Related |
| Principal | captured | membrane | captured | membrane |
| component | (%) | foulant | (%) | Foulant |
| 1 | 63.0 | Humic | 75.0 | Humic |
| | | substances | | substances |
| 2 | 16.4 | Colloidal/ | 9.6 | Colloidal/ |
| | | particulate | | particulate |
| 3 | 5.5 | Protein-like | 6.1 | Protein-like |
| 4 | 4.7 | Colloidal/ | — | — |
| | | particulate | | |
| Total | 89.6 | | 90.7 | |

As further described herein, the statistically significant PCs, calculated as explained above, were found to be correlated to different membrane foulants such as HS-like, protein-like and particulate/colioidal matter present in water. The evolution of these PC scores corresponding to the principal components and consequently to the foulant fractions present in water, was expected to be related to the membrane fouling behaviour as demonstrated by Peiris et al. ((2010a) Water Res. 44(1), 185-194 and (2010b) J Membr Sci, 2010:357:62-72). The PC scores (sᵢ) associated with the retentate and permeate of UF processes were therefore used to formulate a model of the fouling behaviour experienced by 60 kDa and 20 kDa membranes.

At this point, as it would be impossible to quantify each of the individual species in natural water that contribute to fouling, a balance was performed on the PC scores which are representative of different groups of foulants (i.e. HS-like, protein-like and colloidal/particulate). In this way, the accumulation of membrane foulants on the surface and in the pores of the membrane was calculated based on the PC score balance for a given group of foulants. These mass balances, performed on the control volume of the solution occupied by the membrane, were formulated as a way to account tor the mass balances of the individual foulant species present in the water. Accordingly, the accumulation of the membrane foulant (j) that contributes to fouling can be represented as follows:

$$\begin{matrix}\frac{d {s}_{j , M}}{d t} = \frac{1}{k {V}_{m}} [ ( 1 - w ) A \frac{Δ P}{μ {R}_{i}} ( {s}_{j , R} - {s}_{j , P} ) - {wL}_{j} ] & ( 1.2 a ) \\ {L}_{j} = {\dot{m}}_{wash} {eff}_{j} {e}^{- {q}_{j} {R}_{i}} {s}_{j , M} \\ for j = 1 , 2 , 3 , … , N and w = 0 or 1 & ( 1.2 b )\end{matrix}$$

where sⱼ is the PC score related to the j^{th} membrane foulant at time=t (i.e. any given time interval); N is the number of PCs generated by PCA which are statistically significant and deemed to be important for capturing the information related to the major groups of foulants; subscripts R, P and M denote retentate, permeate and the membrane, respectively; V_{M} is the volume of the solution occupied by the membrane and k is a parameter that specifies the active portion of V_{M} (i.e. actual portion of V_{M} that participates in the filtration); the effective membrane surface area, TMP and the water viscosity are represented by symbols A, ΔP and μ respectively; \dot{m}_{wash} is the volume flow rate used for periodic membrane back-washing; w is a binary variable that models permeation through the membrane (w=0) or back-washing (w=1); effⱼ represents the efficiency at which the j^{th} foulant fraction (i.e. foulant fraction related to j^{th} PC) was removed during the back-washing; aⱼ is a parameter describing the decay of efficiency in back-washing over time due to irreversible fouling caused by the j^{th} membrane foulant, where irreversible fouling is attributed to the accumulated membrane foulant material that cannot be removed by membrane back-washing; and Rₜ is the membrane resistance at time=1, which is given in terms of the scores as follows:

$${R}_{t} = {R}_{0} + {\sum }_{j = 1}^{N} {β}_{j} {s}_{j , M} + {β}_{inter} \cdot {δ}_{protein , M} \times {s}_{coll , l partic , M} \qquad ( 1.3 )$$

where R₀ is the initial membrane resistance before fouling occurs; βⱼ, j=1, 2, 3, . . . , N are the model parameters; and βᵢₙₜₑᵣ is also a model parameter related to the interaction between protein and colloidal/particulate matter (represented by S_{protein,M} and S_{coll./part.,M} respectively) that contributes to membrane fouling.

The existence of this interaction was found to be significant in a separate correlation analysis study (results not shown) and found to be very important for improving the model predictions of the present method. It should be noted that while the values of the scores (i.e. sⱼ values) change with time as per the differential Equation 1.2a, the β's are regressed off-line and do not change with time. As indicated by the foregoing, the accumulated foulant species content on the membrane (which is based on the PC score balance for a given group of foulants) is used to calculate the membrane resistance at any given time during the filtration operation. The ability of calculating the membrane resistance at any give time period, serves for generating forecasts of membrane fouling over future time horizons.

The processes involved hi the transfer of membrane foulants from the retentate to the membrane or vice versa are quite complex involving deposition of foulants due to attractive forces and removal due to shear stresses acting on the foulant layers. Detailed modeling of these phenomena is difficult. Therefore, it was assumed that the net amount of foulant transfer from the retentate to the membrane is equal to the accumulation of foulants on the surface and in the pores of the membrane as follows:

$${D}_{j} ( {s}_{j , R} - {s}_{j , M} ) = \frac{Δ P}{μ {R}_{t}} ( {s}_{j , R} - {s}_{J , P} ) \qquad ( 1.4 )$$

where Dⱼ is the effective diffusivity coefficient of the j^{th} foulant fraction; and Dⱼ is a lumped parameter that combines all possible mass transfer mechanisms involving the transfer of membrane foulants from the retentate to the membrane or vice versa as mentioned above.

The permeate water flux through the membrane at time=t is expressed as follows:

$${J}_{t} = \frac{Δ P}{μ {R}_{t}} \qquad ( 1.5 )$$

Experimental permeate water flux data obtained by UF runs performed using source water with different DOC content and turbidity values within the ranges as indicated above were used to calibrate the state space model given by the system of Equations 1.2a, 1.2b, 1.3, and 1.5. The model calibration involved the estimation of the model parameters k, β₁, β₂, β₃, . . . , β_{N}, βᵢₙₜₑᵣ, eff₁, eff₂, eff₃, . . . , eff_{N} and q. This was achieved by minimizing the sum of squares error (SSE) between experimental and model estimations of permeate water flux by using the MATLAB™ function “ga”, a genetic algorithm code available within the MATLAB 7.8.0 (TM) computational environment. Model parameters, estimated in separate model calibrations for 60 kDa and 20 kDa UF membranes, are listed in Table 2 below.

TABLE 2
PARAMETERS USED IN THE MODELING OF 60 KDA AND
20 KDA UF PROCESSES

| | Model for 60 kDa UF | Model for 20 kDa UF |
|---|---|---|
| Parameter | membrane | membrane |
| Calculated/measured | | |
| A | 42.09e−4 m² | 42.09e−4² |
| \check{m}_{wash} | 2.56e−7 m³s⁻¹ | 2.56e−7 m³s⁻¹ |
| Rₒ | 2.76e12 m⁻¹ | 4.01e12 m⁻¹ |
| Vₘ | 9.68e−6 m³ | 9.68e−6 m³ |
| ΔP | 103.35 kPa | 103.35 kPa |
| M | 9e−4 Nsm⁻² | 9e−4 Nsm⁻² |
| Estimated* | | |
| β₁ | 1.63e7 | 1.44e7 |
| β₂ | 7.14e8 | 8.84e8 |
| β₃ | 1.18e8 | 1.48e8 |
| β₄ | 9.57e7 | — |
| βᵢₙₜₑᵣ | −5.01e4 | −3.96e4 |
| eff₁ | 0.1 | 0.2 |
| eff₂ | 0.4 | 0.5 |
| eff₃ | 0.2 | 0.3 |
| eff₄ | 0.3 | — |
| K | 0.24 | 0.23 |
| q₁ | −7e−14 | −1e−13 |
| q₂ | −9e−14 | −1.25e−13 |
| q₃ | −7e−14 | −1e−13 |
| q₄ | −8e−14 | — |
| W | 1 or 0 | 1 or 0 |
| Z₁ | 0.67 | 0.60 |
| Z₂ | 0.60 | 0.60 |

*It should be noted that the units of parameters: βⱼ (j = 1, 2, . . . , 4) and βᵢₙₜₑᵣ are not given as the scores (sᵢ) are considered to be unit less. Nevertheless, βⱼsⱼ and βᵢₙₜₑᵣs_{protein·}s_{coll./partic.} have the unit “m⁻¹”.

The model estimations were generated using the PC scorns of retenlate (s_{j,R}) and permeate (s_{j,P}) that correspond to fluorescence EEM measurements, obtained every 15 minutes during the course of UF. These scores were used as inputs to Equations 1.2a and 1.2b whereas the output was the corresponding score value at the membrane s_{j,M} calculated from Equation 1.2a. The MATLAB™ ordinary differential Equation (ODE) solver “ode23” was used in solving the above state space model. Model, validation was achieved using additional experimental permeate water flux and fluorescence EEMs data that were not used in the calibration. UF experimental data with low, medium and high fouling events involving data from a total of 9 and 10 experiments for 60 and 20 kDa UF membranes, respectively, were used for model validation.

The model of the present invention, given by the system of Equations 1.2a, 1.2b, 1.3, 1.4 and 1.5, was then used to obtain model predictions based solely on the fluorescence EEMs of retentate and permeate captured at time=15 minutes from the start of the UF experiments. PC scores (s_{j,R}_{_{—}}₁₅ₘᵢₙ and s_{j,p}_{_{—}}_{15 min}) that are related to these fluorescence measurements were used for the estimation of the predicted permeate water flux into the future along a total time horizon of 4 hours. During the calculations of model predictions, the PC scores related to the retentate were assumed to be constant and equal to the values obtained at time=15 minutes during the prediction period (i.e. s_{j,R}=s_{j,R}_{_{—}}₁₅ₘᵢₙ in Equation 1.4). This assumption was based on the very small changes (<5% increase in most cases) in the PC scores of retentate observed during the UF experiments. Also, the initial estimations of the effective diffusivity coefficient Dⱼ(j=1, 2, 3, . . . , N) was calculated using Equation 1.4 based on PC scores corresponding to the fluorescence EEMs of retentate and permeate captured at time=15 minutes. These initial estimations were subsequently updated according to the following equation during the calculation of model predictions to account for the change of Dⱼ resulting from membrane fouling over time. This was deemed to be necessary for approximating the evolving fouling conditions over time.

D_{j,t}=z₁D_{j,}_{ᵢₙₜ}+z₂D_{j,t-Δt} for j=1, 2, 3,. . . , N (1.6)

where D_{j,t} is the effective diffusivity coefficient of the j^{th} foulant fraction at time t=t; D_{j,int}=is the initial estimate of Dⱼ; D_{j,t-Δt} is the value of Dⱼ at time t=t−Δt; Δt is the constant time step length (Δt=1 s) used by the ODE solver; and Z₁ and Z₂ are parameters that were estimated by minimizing the SSE between model predictions and measured permeate water flux using a genetic algorithm approach as mentioned above.

It should also be noted that Expiation 1.6 does not necessarily cause Dⱼ to increase over time. As the accumulation of foulant content in the membrane increases, the removal of foulants from the membrane to the retentate becomes significant, causing Dⱼ to decrease as per Equation 1.4. The prediction ability of the model was also validated with additional experimental permeate water flux and fluorescence EEM data that were not used in estimating the Z₁ and Z₂ parameters.

The predicted permeate water flux can be used to understand the extent of fouling of the membrane and the reduced permeate water flux occurring over time for constant TMP operations. However, if constant permeate flux is desired, the TMP would increase as a result of fouling. In both situations, membrane fouling results in an increase in the energy requirement per unit amount of drinking water produced.

In the method of the present invention, UF membrane back-washing times are used as optimization variables to optimize the UF process so that the energy requirement per unit amount of drinking water produced is minimized. In the example embodiment, this optimization approach was implemented by minimizing the following objective function (OF), (Equation 1.7) subjected to the constraints listed in Equations 1.10 and 1.11.

$$OF = \frac{Energy consumption}{Water production} \qquad ( 1.7 )$$

where energy consumption and the water production for time duration=Δt is given by;

$$Energy consumption = \frac{{A ( Δ P )}^{2} Δ t}{μ {R}_{t}} \qquad ( 1.8 )$$

Water production=JₜAΔt (1.9)

$$[ \begin{matrix}1 & - 1 & 0 & 0 \\ 0 & 1 & - 1 & 0 \\ 0 & 0 & 1 & - 1 \\ 0 & 0 & 0 & 1\end{matrix} ] [ \begin{matrix}{t}_{1} \\ {t}_{2} \\ {t}_{3} \\ {t}_{4}\end{matrix} ] \leq [ \begin{matrix}- {t}_{w} \\ - {t}_{w} \\ - {t}_{w} \\ {t}_{F} - {t}_{w}\end{matrix} ] \qquad ( 1.10 )$$

t₁≧t_{d} (1.11)

where t₁, t₂, t₃ and t₄ are the times at which the back-washing of the UF membrane was implemented.

In the example, the number of back-washing cycles was limited to four as this was sufficient to demonstrate the application of the proposed approach. The number of back-washes represents another parameter that could optionally be included in this optimization approach. Also, t_{w}=180 s is the sum of the time for back-washing (20 s) and the time required to connect and disconnect the Nitrogen gas supply for back-washing and for adjusting the TMP of the UF membrane cell holder (160 s), which were performed manually. The total filtration time is indicated by tₚ(=257 min) and t_{d}(=15 mm) is the time at which the first set of fluorescence EEMs of the retentate and permeate for UF operation were collected. The minimization of the OF (Equation 1.7) subjected to the constraints (Equations 1.10 and 1.11) were performed by using the MATLAB™ function “ga”.

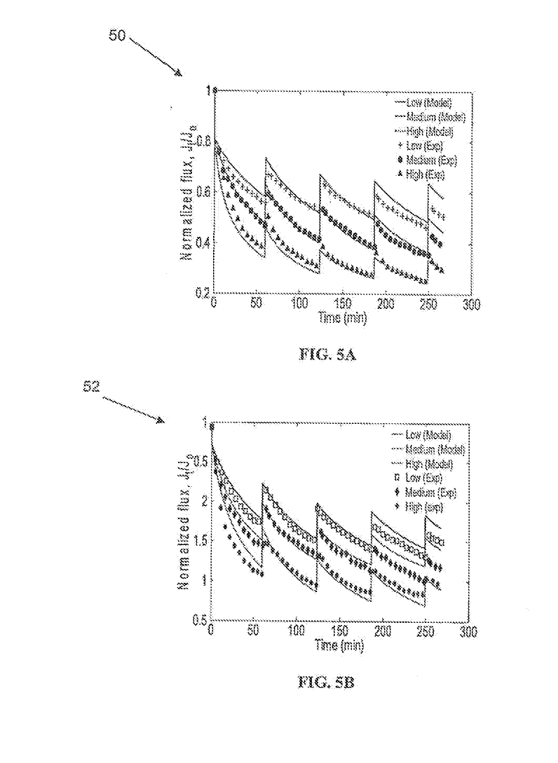

Reference numerals 40 and 42 indicated on FIG. 4A and FIG. 4B, respectively, denote model predictions and the experimentally measured normalized permeate water flux of selected 60 kDa and 20 kDa UF experiments that were not used in the model calibration/parameter estimation described above. Permeate flux was normalized with respect to initial pure water flux of the membranes. These experiments correspond to low, medium and high membrane fouling situations. The sudden increase in permeate flux occurring immediately after the exponential-type flux declines of the permeation step corresponds to membrane back-washing. FIG. 5A and FIG. 5B show model predictions (at reference numerals 50 and 52, respectively) and experimentally measured (symbols) normalized permeate water flux obtained for (A) 60 kDa and (B) 20 kDa OF operations with normal back-washing (BW) times (every hour) and optimized back-washing times.

The model predictions for these experiments were obtained using only the fluorescence-based PC scores of retentate and permeate obtained at time=15 minutes of the UF. The permeate flux prediction results indicate that the predictive model of the present invention is able to successfully forecast different membrane fouling behaviours experienced by both UF membrane types. These results further indicate that the fouling modeling approach of the present invention can be used for forecasting different fouling behaviours corresponding to changes in membrane feed water quality. Hence, this modeling approach can be used to detect high membrane fouling events well in advance and thus appropriate process optimization measures could be implemented to ensure sustainable operation of drinking water treatment systems.

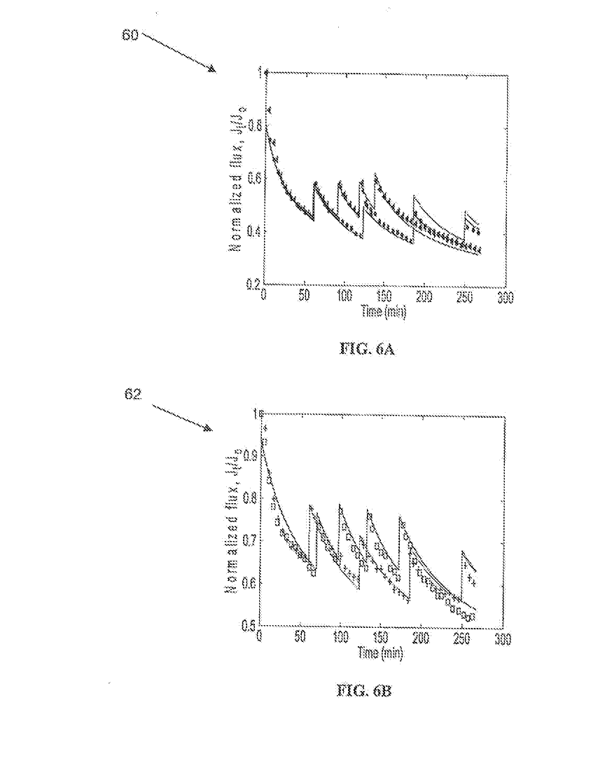

FIG. 6A and FIG. 6B demonstrate the model forecasts at reference numerals 60 and 62, respectively, of the fouling behaviour for UF of source water (pre-filtered) using 60 kDa (60) and 20 kDa membranes (62), with back-washing at regular time intervals of 1 hour (i.e. before implementing optimal backwashiug intervals). When back-washing times were optimized using the optimization approach described above for the 60 kDa membrane, the model forecasts indicated an energy savings of 3.7% with a 4.3% increase in the total volume of drinking water production. The back-washing times generated by the optimization approach were t₁=61 min, t₂=90 min, t₃=118 min, and t₄=137 min. Applying the same approach for the 20 kDa membrane, it was possible to achieve energy savings of 2.6% with a 3.1% increase in the total volume of water production. The corresponding optimum back-washing times for the 20 kDa membrane were t₁=69 min, t₂=97 min, t₃=132 min, and t₄=172 min. The optimal backwashing cycles were implemented experimentally in order to test the validity of the optimization results. The results of these experiments are shown in FIGS. 6A and 6B, indicating good agreement between experimental values and model forecasts thus confirming the optimization solution.

Although the experimental implementation of the optimization approach described herein was limited to four back-washing cycles, it is possible to further improve the energy savings and the water production by employing additional back-washing cycles with the optimized conditions. For example, when two additional back-washing cycles were included as illustrated in FIG. 6A, the model predictions indicated an increase in the energy savings and the volume of drinking water production up to ˜8.0% and 9.8% respectively. The use of additional back-washing cycles will also limit the high fouling behaviour of the membrane that may occur even when the optimised back-washing is implemented towards the end of filtration, hi addition, optimal operation will further extend the life span of the membrane and minimize the need for chemical cleaning to recover flux decline caused by irreversible fouling.

The ability of the modeling method of the present invention to reasonably predict the reversible and irreversible fouling behaviour experienced by both 60 kDa and 20 kDa membranes with back-washing time intervals that are different to those employed in the model calibration, indicates that the proposed predictive modeling approach is ideal for modeling different filtration situations (e.g, generally unplanned or infrequent) which are difficult to model.

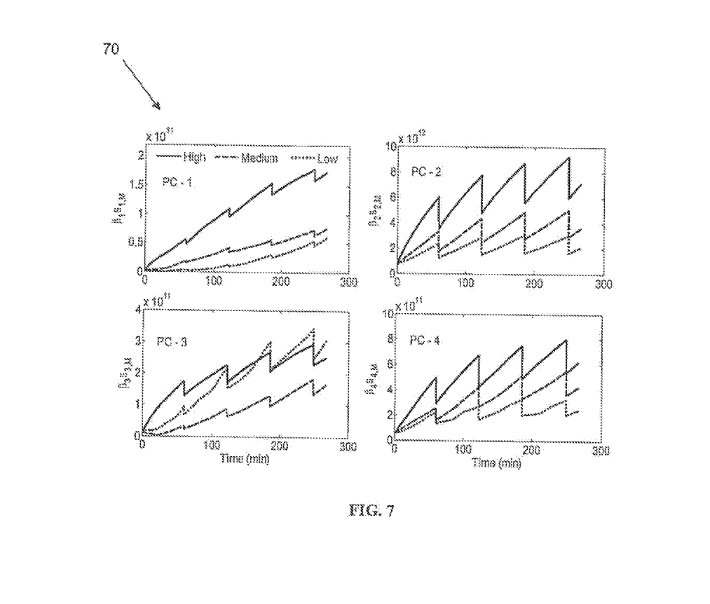

Another important aspect of the modeling method of the present invention is that it can be used to estimate the accumulation of individual foulant components in/on the membranes in terms of PC scores (i.e. s_{j,M}; where j is the PC related to the j^{th} foulant component) as illustrated in Equations 1.2a and 1.2b. For the purposes of brevity, elsewhere in this specification reference to the phrase “accumulation of foulards on membrane” is meant to include both accumulations on the membrane surface as well as accumulations in the pores of the membrane itself. These individual membrane foulant components contribute differently to the increase in the membrane resistance (Rₜ) and this relative contribution is quantified by the value of βⱼs_{j,M} for each foulant component (j) In Equation 1.3. Therefore, by examining the evolution of βⱼs_{j,M} (for j=1,2,3,4), one can assess how different membrane fouling components contribute to membrane fouling. FIG. 7 illustrates the evolution of these estimates for the main foulant components, such as HS-like, protein-like and colloidal/particulate matter for high, medium and low fouling events experienced by 60 kDa membranes. Similar observations were made for 20 kDa membranes. The corresponding PCs are also indicated in FIG. 7 (PC-1 to PC-4), indicated at reference numeral 70, as calculated in terms of the accumulation of individual foulant components in/on the membranes.

It should he noted that these estimates were calculated using the PC scores related to fluorescence EEMs of retentate and permeate obtained during the course of the UF experiments using Equations 1.2a, 1.2b and 1.3. Thus, these model estimates obtained through Equation 1.2a with actual fluorescence data collected along the experiment are representative of the foulant accumulation on the membranes during the course of the 60 kDa UF experiments. As previously mentioned, the forecasting model of the present invention may he based on fluorescence measurement alone or it can be based on the combination of fluorescence and other available fluid filtration measurements, including standard measurements such as trans-membrane pressure, permeate flux, turbidity and DOC. For example, using a Kalman filter algorithm, the balances of PC scores based on fluorescence EEMs may be combined with these other standard fluid filtration measurements to improve fouling forecasting accuracy. In one embodiment, using the Extended Kalman filter (EKF) approach, current (time=current time) trans-membrane pressure readings can be combined with UF permeate flux measurements or principal component (PC) scores related to current fluorescence measurements of membrane permeate to update the key model parameters by utilizing the recursive updating equations available within the EKF algorithm. Based on the current (time=current time) process measurements, this approach updates model parameters so that the error between model estimations and measured values is minimized. Of course, if other online water characteristic measurements such as TOC, permeate flux, turbidity, LC-OCD and/or DOC measurements are available, such measurements can also be used in combination with EKF approach to update the model parameters accordingly.

The cyclical drops in βⱼS_{j,M} values in FIG. 7 are correlated with the flux increase or alternatively fouling decrease obtained after membrane back-washing as illustrated in FIG. 5A and FIG. 5B. Based on the relatively larger changes observed after back-washing for PC-2 and PC-4 one can conclude that collloidal/particulate matter accumulated in/on the membranes was removed predominantly by back-washing compared to HS- and protein-like foulants. As a result, colloidal/particulate matter demonstrates a comparatively larger contribution to reversible fouling. HS- and protein-like foulants, on the other hand, are seen to be contributing significantly towards irreversible fooling (i.e. smaller drop in β₁S_{1,M} and β₂S_{2,M} values after back-washes). These observations are consistent with interpretations provided for reversible and irreversible UF fouling by river water foulant extracts (Jucker and Clark, Adsorption of aquatic humic substances on hydrophobic ultrafiltration membranes. J Membrane Sci. 1994;97;37-52; Aoustin et al. Ultrafiltration of natural organic matter. Sep Pur Tech. 2001;22-23:63-78) and model foulants (Jones and O'Melia, Ultrafiltration of protein and humic substances: effect of solution chemistry on fouling and flux decline. J Membrane Sci. 2001; 193(2);163-173; Jermann et al. Influence of interactions between NOM and particles on UF fouling mechanisms. Water Res.2008;42(14);3870-3878). Therefore, the proposed modeling approach allows identification of the type of foulant components in the water that are contributing to reversible and irreversible fouling eliminating the need to perform membrane autopsy analyses which are difficult and time consuming. In addition to drinking water treatment related membrane applications, this approach could also have application in other types of membrane-based treatment or separation of substances that have intrinsic fluorescence properties or systems that contain fluorescent tags.

What is claimed is:

1. A method of forecasting the accumulation of foulants on a membrane during the course of fluid filtration operation, characterized by the steps of:
a. measuring fluorescence intensities for feed, retentate and permeate fluid samples at time intervals of fluid filtration operation to generate fluorescence intensity values corresponding to each fluid sample;
b. rearranging the fluorescence intensity values to produce a data matrix, wherein each row of the data matrix contains fluorescence data points corresponding to each fluid sample;
c. applying principal component analysis to the data matrix to generate principal component scores, wherein each principal component score represents a quantity of a corresponding foulant species group within each fluid sample;
d. performing balances on the principal component scores by calculation of the accumulation of each group of foulant species on the membrane, wherein the accumulation of each group of foulant species on the membrane is calculable at any given time interval (t) of fluid filtration operation; and
e. calculating membrane resistance at a given time interval (t) of fluid filtration operation by correlating to balanced principal component scores at time interval t.

2. The method of claim 1 further characterized by the step of calculating a membrane cleaning schedule for minimizing the energy required for fluid filtration operation and maximizing clean fluid production, on the basis of the balanced principal component scores.

3. The method of claim 1 wherein the calculation of the accumulation of each group of foulant species on the membrane is taken from the net effect of the following mass flows:
a. amount of foulant species in the feed or retentate;
b. amount of foulant species in the permeate; and
c. amount of foulant species removed by membrane cleaning.

4. The method of claim 1 wherein the fluorescent intensities are measured by fluorescence excitation-emission matrix spectroscopy.

5. The method of claim 1 further, characterized by the step of auto-scaling the data matrix before the step of applying principal component analysis.

6. The method of claim 1 wherein the filtration takes the form of ultrafiltration (UF) cross flow operations and could also be applicable for UF dead-end configurations.

7. The method of claim 1 wherein the time intervals of fluorescence measurements are all of a uniform duration.

8. The method of claim 1 wherein the time intervals are 15 minute intervals.

9. The method of claim 1 wherein the time intervals are variable in duration.

10. The method of claim 1 wherein the membrane is a flat sheet UF membrane.

11. The method of claim 1 wherein the membrane has a molecular weight in the range of 20 kDa to 60 kDa.

12. The method of claim 1 wherein the fluid filtration consists of a two-step operation cycle of permeation and membrane cleaning

13. The method of claim 12 wherein the membrane cleaning takes the form of membrane back-washing.

14. The method of claim 12 wherein the membrane cleaning takes the form of membrane chemical cleaning.

15. The method of claim 1 wherein the fluid filtration operation is a water filtration operation.

16. The method of claim 1 further characterized by the step of combining the principal component scores with standard fluid filtration measurements in a Kalman filter algorithm.

17. The method of claim 16 wherein the standard fluid filtration measurements are selected from the group consisting of trans-membrane pressure, permeate flux, turbidity, and dissolved organic carbon.
